(19) United States
(12) Patent Application Publication
(10) Pub. No.: US 2007/0270027 A1
(43) Pub. Date: Nov. 22, 2007

(54) CONNECTOR HAVING ADJUSTABLE CABLE

(76) Inventor: Kui-Hsien Huang, Taipei City (TW)

Correspondence Address: LEONG C LEI, PMB # 1008, 1867 YGNACIO VALLEY ROAD, WALNUT CREEK, CA, 94598, US

(21) Appl. No.: 11/383,500

(22) Filed: May 16, 2006

(51) Int. Cl. H01R 13/72

(52) U.S. Cl. 439/501

(57) ABSTRACT

A connector having adjustable cable is disclosed. The connector is characterized in that the main housing is the outer housing of the terminal end of the connector which holds the terminal platform, the male or female connector and the circuit board, forming into a body and the circuit board is positioned as the bottom section which is a base layer, and the terminal platform is positioned at the top section of the circuit board and is positioned at the rear position of the male or female connector, and the terminal platform is horizontally arranged which is soldered onto the circuit board, and the platform surface of each terminal platform is provided with cable hole and a locking slot such that a locking element is used to lock the cable, and the male or female connector is positioned at the top section of the circuit board and at the extreme front position and the connector is provided with pin which is 90 degree and is soldered to the circuit board for sealing.

### BACKGROUND OF THE INVENTION

(a) Technical Field of the Invention

The present invention relates to connector, and in particular, to a connector having a cable which can be adjusted.

(b) Description of the Prior Art

Conventional connector with a cable is generally too long or too short when in use. If the length of the cable is too long, there is a drawback that the cable entangles the user's or other items, and this will cause problem with respect to data transmission. If the length of cable of the connector is too short, it causes the connector to be not useful and a new one has to be employed. If the connector is to be used for a longer distance, the connector has to be extended and this will affect the quality of transmission.

It view of the above drawbacks, it is an object of the present invention to provide a connector with adjustable cable to provide users with appropriate length of cable.

### SUMMARY OF THE INVENTION

The primary purpose of the present invention is to provide a connector having adjustable cable comprising a main housing, a circuit, a terminal platform, a male or female connector, and screw bolts characterized in that the main housing is the outer housing of the terminal end of the connector which holds the terminal platform, the male or female connector and the circuit board, forming into a body and the circuit board is positioned as the bottom section which is a base layer, and the terminal platform is positioned at the top section of the circuit board and is positioned at the rear position of the male or female connector, and the terminal platform is horizontally arranged which is soldered onto the circuit board, and the platform surface of each terminal platform is provided with cable hole and a locking slot such that a locking element is used to lock the cable, and the male or female connector is positioned at the top section of the circuit board and at the extreme front position and the connector is provided with pin which is 90 degree and is soldered to the circuit board for sealing.

Yet another object of the present invention is to provide a connector having adjustable cable, wherein the main housing comprises an upper housing and a lower housing connected at the lateral side and the two housings facing each other and is engaged with each other, and the upper housing has a side being provided with one or more than one fastening peg which is corresponding to a pegging slot on the lower housing such that the two housings after combination are engaged and fastened.

Still another object of the present invention is to provide a connector having adjustable cable, wherein the rear position of the upper and lower housings are each provided with an engaging mount and the outer side of the mount has one or more than one fastening peg which corresponds to a pegging slot at the outer side of the engaging mount of the other housing, allowing the fastening and locking of the cable.

Yet a further object of the present invention is to provide a connector having adjustable cable, wherein the two lateral sides of the male or female connector are provided with through holes for the passing of the screw bolt.

A further object of the present invention is to provide a connector having adjustable cable, wherein the rear position of the male or female connector is formed as a packing body which can be glued to seal so as to protect the pin.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a schematic view showing the terminal platform, male or female connector and the circuit board of the present invention.

FIG. 4 is a top and front view of the present invention.

FIG. 5 is a sectional view of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

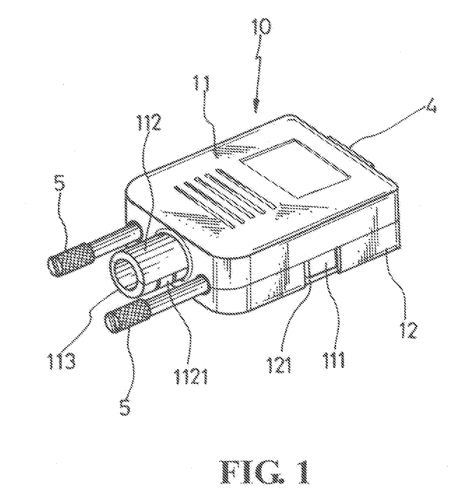

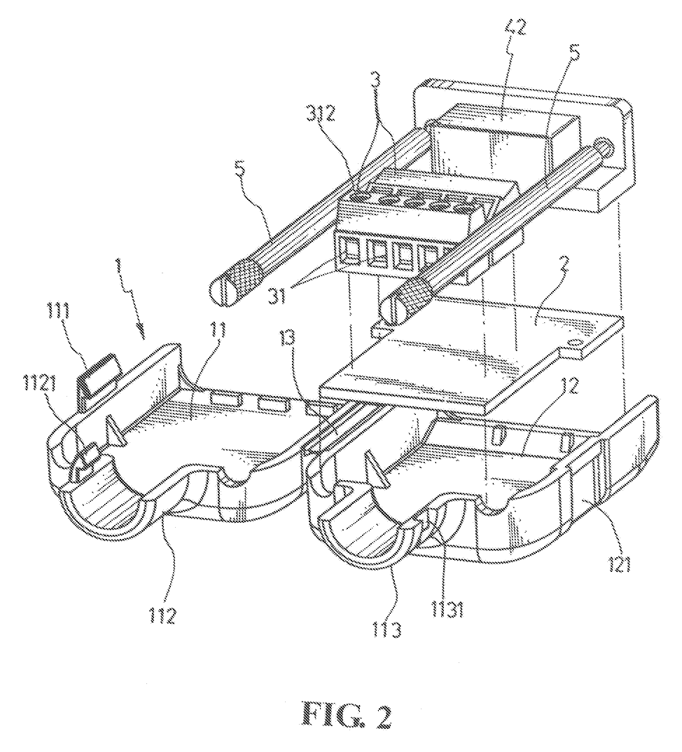

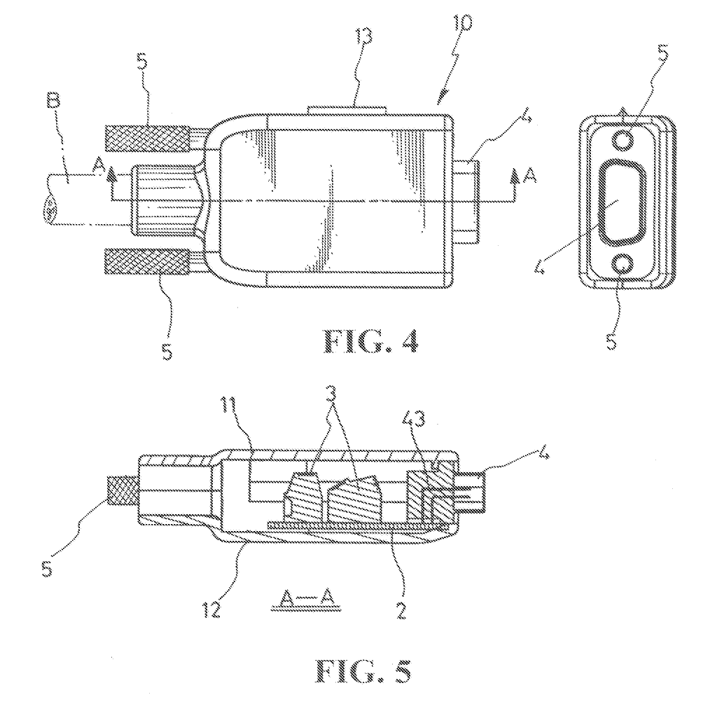

Referring to FIG. 1, there is shown a connector or data connector end 10 having a female connector 4 in combination with a locking screw bolt 5 at two lateral sides. As shown in FIG. 2, the connector end 10 comprises a main housing 1 with side connection, a circuit board 2, a terminal platform 3, a male or female connector 4 and a locking screw bolt 5 at the two lateral sides. The main housing 1 includes an upper housing 11 and lower housing 12 and a linking wall 13 to connect the two housings 11, 12. After the two housing 11, 12 are correspondingly mounted, the circuit board 2, the terminal platform 3, the male or female connector 4 and a partial of the screw bolt 5 are enclosed within the interior of the main housing 1. Thus, the upper housing 11 has one or more than one fastening peg 11 at one side of the housing with the non-linking wall 13, which is corresponding to a pegging slot 121 at the non-linking wall 13 of the lower housing 12. The pegging slot 121 and the peg 111 are for securing and fastening. In addition, the cable A is mounted and secured. The rear direction of the two housings 11, 12 are provided with an engaging mount 112, 113, and the outer side of the engaging mount 112 is one or more than one fastening peg 1121 which corresponding to the pegging slot 1131 on the outer side of another engaging mount 113. When the two engaging mounts 112, 113 are secured, the structure is used for the holding of a cable B, as shown in FIG. 4.

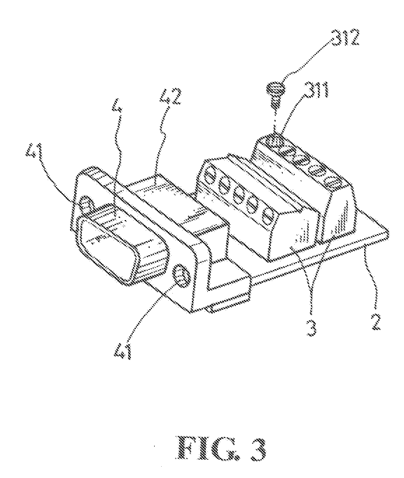

Referring to FIG. 3, the terminal platform 3, the male or female connector 4 and the circuit board 2 are positioned within the interior of the connector 10 to form as one unit. The circuit board 2 is positioned at the bottom section as the base layer and the terminal platform is at the upper position of the circuit board 2 which is at the rear position of the male or female connector 4 and is positioned horizontally and are soldered in a front and rear position. Referring to FIG. 2, the platform surface of the terminal platform 3 has a through hole 31 facing externally, and the through hole 31 at the rear end of the terminal platform is also facing outside and is provided with a slanting face facilitating the securing of cable. The platform of each terminal platform 3 is provided with a plurality of holes 31 and each through hole 31 has a corresponding engaging slot 311 for screwing a locking element 312 so that a branching cable of the cable B can be extended and locked.

Referring to FIGS. 3 and 5, the male or female connector 4 is positioned at the top section and the extreme front direction of the circuit board, and the end section of the connector 4 is extended is a through hole 41 allowing a locking screw bolt 5 to pass through for fastening. The rear position of the extension head 4 is a sealing body 42 forming as a unit with connector so that the pin 43 of the connector 4 is extended to 90 degree and is soldered to the circuit board 2. The sealing body 42 is used for sealing or gluing for protection. Therefore, the conductive end at this point will not expose to external.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-5. (canceled)

6. A connector comprising:
a main housing including a first housing, a second housing and a linking portion positioned between said first housing and said second housing and connecting said first housing to said second housing, said first housing having a fastening peg, said second housing having a pegging slot adapted to engage with said fastening peg, said first housing having a first neck provided with a first fastening peg, said second housing having a second neck provided with a second pegging groove adapted to engage with said first fastening peg;
a socket mounted on another end of said main housing; and
a circuit board arranged within said main housing;
a first terminal platform mounted on said circuit board and provided with a plurality of engaging slots each engaged with a locking element;
a second terminal platform mounted on said circuit board and arranged between said first terminal platform and said necks, said second terminal platform being formed at a top with a plurality of engaging slots each engaged with a locking element; and
two locking screw bolts passing through said main housing for fastening.
